(19) United States
(12) Patent Application Publication
(10) Pub. No.: US 2015/0371190 A1
(43) Pub. Date: Dec. 24, 2015

(54) SYSTEMS AND METHODS FOR PROVISIONING A FLEET OF INDUSTRIAL ASSETS AS A COMPUTING-CLOUD

(71) Applicant: General Electric Company, Schenectady, NY (US)

(72) Inventor: Naresh Sundaram Iyer, Ballston Spa, NY (US)

(21) Appl. No.: 14/312,233

(22) Filed: Jun. 23, 2014

(51) Int. Cl. G06Q 10/10; H04L 29/08

(52) U.S. Cl. CPC G06Q 10/103; H04L 67/10

(57) ABSTRACT

A system and method for leveraging industrial asset computing capacity into a distributed computing system is disclosed. The method including receiving from a requesting entity a request for available computing capacity, the request including at least one computational task, determining the available computing capacity across a network of interconnected industrial assets, each industrial asset including at least one central controller, allocating at least one of the interconnected industrial assets to perform at least a portion of the computational request, providing the allocated industrial assets with computer executable instructions and data related to performing the computational request, performing at least a portion of the computational request at the allocated industrial assets, obtaining the results of the performing step from the allocated industrial assets; and returning the obtained results to the requesting entity. A system to implement the method and a computer-readable medium are disclosed.

### BACKGROUND

Conventional distributed computing involves running portions of a program or application on many computers at the same time, where the many computers are connected over a network. Conventionally, desktop computer instruction cycles that would otherwise be unused are scavenged, or shared. These under-utilized, unused instruction cycles might be available due to time-of-day (e.g., night, off-hours, lunch, etc.), excess processing power, etc.

For example, the Berkeley Open Infrastructure for Network Computing (BOINC) project uses unused processor cycles on distributed computers to do scientific computing. In this manner, BOINC harness the power of networked PCs worldwide, in order to solve CPU-intensive research problems.

The concept “cloud computing” has become popularized through marketing campaigns. Conceptually, cloud computing delivers computing power from a data center facility or server farm, which is constructed to sell processor cycles in a marketplace environment. The data center facility typically includes computer systems and associated communication and memory storage systems, with backup power supplies. Traditional cloud computing infrastructure involves explicit purchase and setting up of hundreds of thousands of traditional computing devices like servers and workstations.

FIG. 1 depicts a structural block diagram of a conventional industrial asset 100. The industrial asset can include at least one central controller 110. The central controller may be a processing unit, a field programmable gate array, discrete analog circuitry, digital circuitry, an application specific integrated circuit, a digital signal processor, a reduced instruction set computer processor, etc. Industrial asset 100 can include internal memory 130 (e.g., volatile and/or non-volatile memory devices) coupled to the central controller. The central controller may access control software application program 140 stored in non-volatile internal memory, or stored in an external memory that can be connected to the central controller via input/output (I/O) port 150. The I/O port can be coupled to any hardwire network connection and/or wireless network connection. The control software application program 140 may include code or executable instructions that when executed by the central controller 110 may instruct, or cause, the central controller and other components to cause mechanical operation unit 120 to perform a primary mechanical function.

Communication between the components 110, 120, 130, 140, 150 of the industrial asset 100 can be over electronic communication network 160, or a dedicated communication path. In some implementations, network 160 can be an internal or external communication bus.

In today's world, industrial assets like gas turbines, locomotives, automobiles, aircraft engines, domestic appliances, etc. come with a significant capability for automated control. Their automated control is enabled by one or more controller units built into the assets. These controller units tend to be self-sufficient, computing devices comparable with traditional computing devices that are explicitly designed for computing. What is needed in the art is a mechanism that leverages existing industrial infrastructure, and its unused/underutilized processor cycles, to provide a distributed computing, or cloud computing, capability.

### BRIEF DESCRIPTION OF THE DRAWINGS

FIG. 1 depicts a block diagram of a conventional industrial asset;

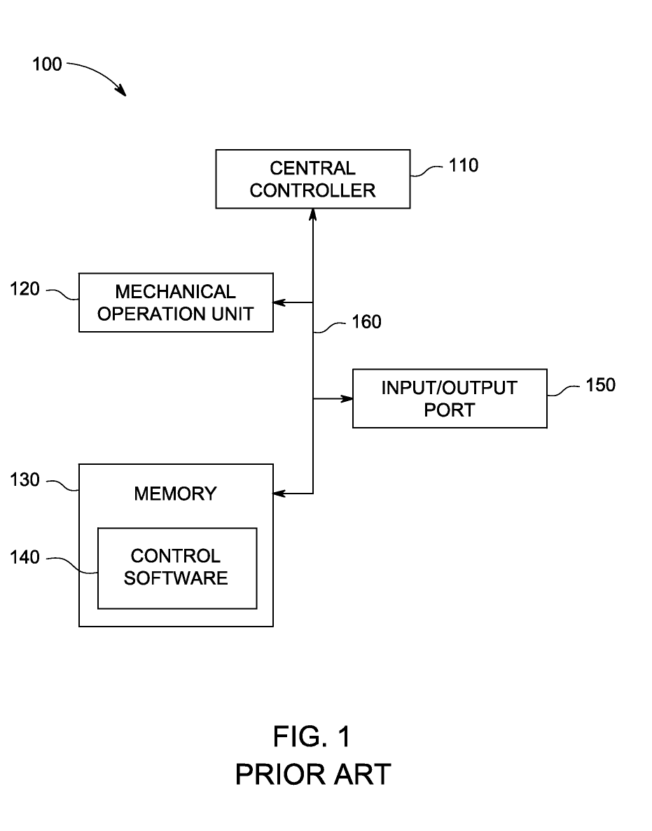

FIG. 2 depicts an industrial asset computing cloud system in accordance with some embodiments;

FIG. 3 depicts a multi-modal industrial asset computing cloud system in accordance with some embodiments;

FIG. 4 depicts a block diagram of an industrial asset computing cloud system in accordance with some embodiments; and

FIG. 5 depicts a process in accordance with some embodiments.

### DETAILED DESCRIPTION

Systems and methods, in accordance with embodiments, couples the availability of excess computing capability in industrial assets with the industrial internet era. For example, a large number of industrial assets can already be connected to a network that monitors and/or controls, the performance of the industrial assets.

In accordance with an embodiment, an Asset Computing Cloud (AC2) system provides a distributed computing system that leverages the unused and/or underutilized computing processor power of industrial assets to provide computing power to programs, or applications, that access the industrial assets' control processor via the monitoring network. The term “industrial asset” as used herein defines a device that is designed with a primary purpose other than computing, but performs this primary purpose under the control of at least one computing device embedded within the industrial asset, where the computing device is remotely accessible over an electronic communication network. Examples of industrial assets can include, but are not limited to, gas turbines, locomotive engines, automobile engines, aircraft engines, artificial satellites, appliances (domestic and/or commercial), medical imaging equipment, etc.

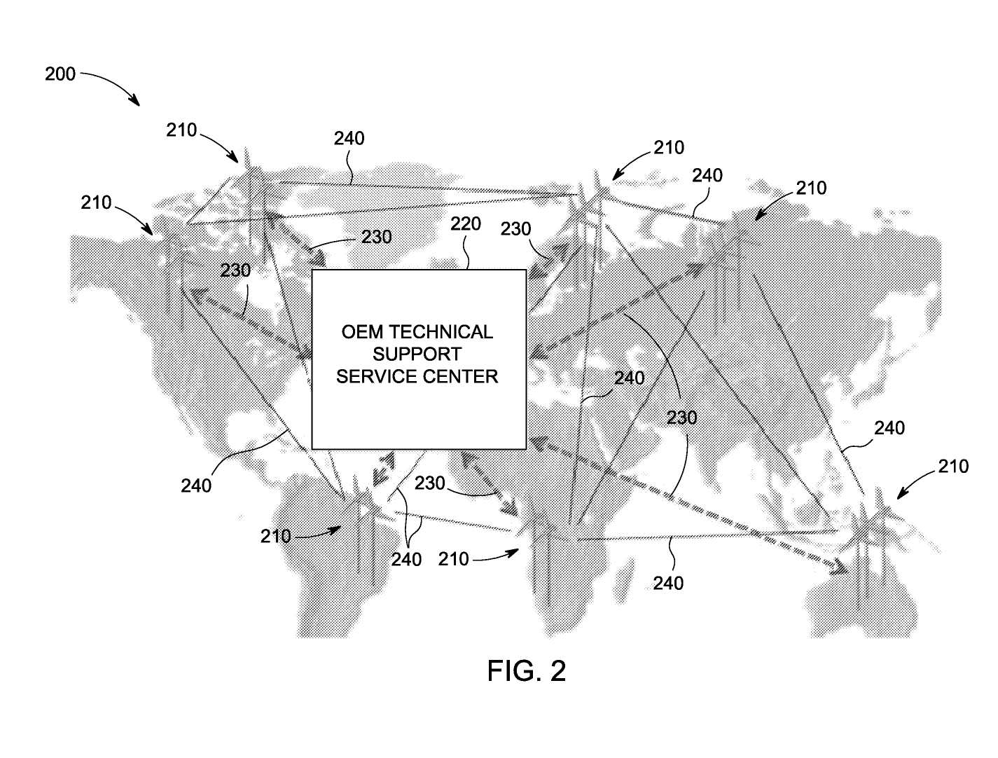

FIG. 2 depicts industrial asset computing cloud system 200 in accordance with some embodiments. AC2 system 200 is based on utilizing OEM technical support service center (OEM TSSC) 220 that has one or more communication links 230 to operational, industrial assets 210 deployed in the field. The OEM TSSC can have the primary purpose of providing monitoring capabilities of the industrial asset operation.

In accordance with embodiments, one or more industrial assets can be provisioned to include the capability and structure to configure the industrial asset to implement the AC2 implementation of the asset itself. This provisioning can include structuring the asset to be network-connected under a service similar to traditional Infrastructure as a Service (IaaS). The consumers of the AC2 service can be charged rates to pay for utilizing this computing-on-demand service similar to paying for use of traditional IaaS system.

In accordance with some embodiments, the OEM leverages existing, centralized, remotely-located technical support centers that are network connected to operational assets. These technical support centers can act as a hub to control the AC2 service. Additionally, the design and operation of additional hardware and/or software necessary to instantiate and host the asset computing cloud can be implemented from this hub. This analysis of requirements for instantiating and hosting the asset computing cloud can be performed at the technical support center. This analysis can include such factors as the historical usage of the industrial asset's embedded controller, customer task, and location. These factors are used in a forecasting model that robustly estimates available computing time at the industrial assets.

In accordance with some embodiments, the AC2 system can be implemented regardless of the nature of the embedded controller. For example, the embedded controller can be single core or multi-core processor operating disparate operating systems.

A method, in accordance with some embodiments, can include an agreement, and/or collaboration, between the OEM (or the AC2 system provider) with the end user customer of the industrial assets. This agreement/collaboration can include forecasting the available excess computing capacity of a fleet of assets operated by the end user.

This excess computing capacity of the industrial assets can be defined as a function of the asset's operation and control schedule. This forecasted capacity can be used to dynamically provision the AC2 capacity available for distribution in the marketplace. In accordance with some embodiments, the forecasting process can be made to assure that the end-user's purposing of the industrial asset has reserve computing power. In accordance with implementations, the forecasting process can include ways in which use of computing-cycles from an asset does not jeopardize the asset's operation, safety, or other requirements and constraints specified by the end user. In accordance with some embodiments, each asset in the fleet of assets leverages, and/or expands, its own computing capacity by accessing the AC2 system to perform its own computing tasks. This added computing capacity can enable individual assets to do complex analysis on data it obtains locally from its own processes/operations, so that the industrial assets themselves can become more self-aware and intelligent.

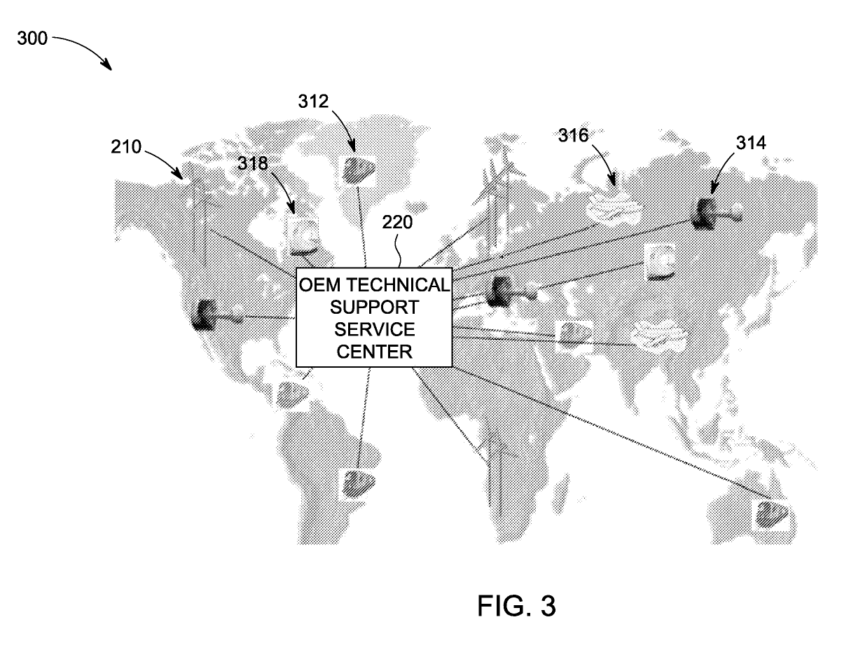

In the implementation depicted in FIG. 2, industrial assets 210 are all of the same functional type (e.g., wind turbine generators), however a multi-modal AC2 system can be implemented. FIG. 3 depicts multi-modal industrial asset computing cloud system 300 in accordance with some embodiments. Depicted in FIG. 3 are such multi-modal assets as wind turbine generator 210, locomotive engine 312, artificial satellite 314, airplane 316, and generator turbine 318. In accordance with the depicted implementation, the AC2 system can be formed by linking industrial assets that are of differing modes and/or purposes, and also either stationary or mobile.

With reference to FIG. 2, the OEM TSSC 220 can be linked to the industrial assets 210 via electronic communication network 230. Command, control, monitored data, software updates, computing applications, data results, etc. can all be carried across the electronic communication network 230. Further, the components of the AC2 system can also be linked by Internet Protocol version 6 (IPv6) communications channel 240. The IPv6 channel provides an identification and location system for devices on networks and routes communication/data traffic across the Internet. Because each industrial asset includes at least one remotely-accessible central controller, IPv6 channel 240 can enable each asset to directly connect to any of the other assets. This interconnection of assets provides a rich networking infrastructure necessary to view the disparately located industrial assets as a computing cloud infrastructure.

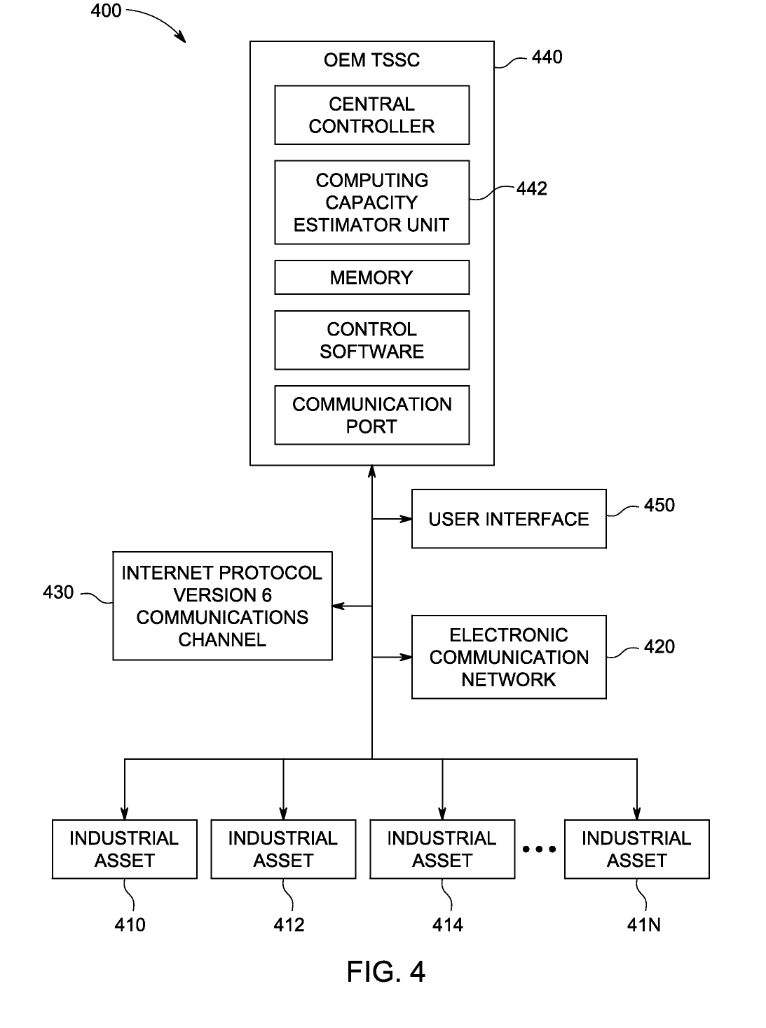

FIG. 4 depicts a block diagram of industrial asset computing cloud system 400 in accordance with some embodiments. AC2 system 400 can include OEM TSSC 440, which is in communication with multiple industrial assets 410, 412, 414, 41N across electronic communication network 420 and/or IPv6 communication channel 430. User interface 450 is also in communication with the OEM TSSC across either the communication network, or the IPv6 channel.

Electronic communication network 420 can be implemented as a private internet protocol (IP) network, the Internet, an integrated services digital network (ISDN), frame relay connections, a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication means. It should be recognized that techniques and systems disclosed herein are not limited by the nature of this external network.

OEM TSSC 440 can include hardware, software, and/or firmware structured to provide the service center with the ability to host the cloud. In accordance with embodiments, OEM TSSC 440 can include computing capacity estimator unit (CCE) 442. The CCE is structured to estimate the available computing capacity of individual industrial assets 410, 412, 414, 41N connected to the OEM TSSC.

The CCE's computation can be based on the asset's operation specific computing requirements. For example, for many asset central controllers the computing duty-cycle is largely regular, typically time-based and occasionally event-based. Based on this, the total available computing capacity across the fleet of assets can be dynamically estimated and allocated to meet requests for computing capacity service received from the user interface. In accordance with implementations, one class of user of the AC2 system can include traditional consumers of computing clouds in the market today. Additionally, one or more industrial assets that are connected in communication with the OEM TSSC can also request computing capacity from the AC2. The industrial asset can make use of this additional computing capacity to accomplish more computational-intensive tasks, like advanced analysis for diagnosing or optimizing operations, than is available to it locally via its central controller.

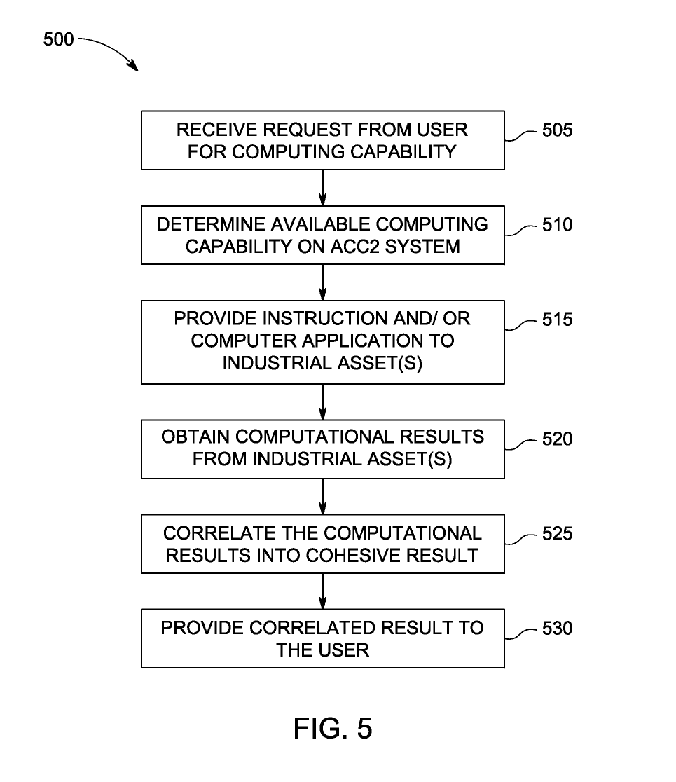

FIG. 5 depict process 500 for leveraging computational capacity of industrial assets in accordance with some embodiments. At step 505 the AC2 system receives a request from a user for computing capability. The request can be forwarded to the industrial asset dynamically, forwarded from a queue of requests, and/or processed as part of a batch. The manner in which the request is forwarded to the industrial asset can be based on various criteria including the order in which the request is received, based on a priority (assigned by the user and/or the AC2), or ranked based on commercial interest (e.g., relationship between the requestor and the AC2 system provider, consideration for a premium service fee, etc.). The AC2 determines available computing capability, step 510, from among the interconnected industrial assets. This determination can be made by the CCE of the OEM TSSC. In accordance with implementations, the determination can be made after receiving the request or by accessing a computer record or database that is periodically updated with computing capacity statistics.

Instruction and/or computer applications are provided, step 515, to the industrial assets allocated to perform the received request. Data used for the computations is also provided or made accessible to the industrial assets. After the industrial assets perform the computation, results are obtained, step 520. In accordance with some embodiments, because the computational task is done in a distributed manner across the AC2, the obtained results could need to be correlated, step 525, into a cohesive result. The correlated results are then provided, step 530, to the requesting user.

Embodying systems and methods commoditize computing infrastructure so that it can be provisioned on-demand and per-use. This commoditized infrastructure can be monetized by charging users of the AC2 system can be charged for the computing cycles provided in response to their requests. Embodiments exploit computing cycles available in devices that are not explicitly designed for purposes of computing. Rather, available computing-cycles from across a large fleet of multimodal, interconnected, remotely-monitored industrial assets are monitored and provided to meet user demand. Each of these industrial assets is abstracted by the AC2 system into a computer as part of an interconnected set of computing resources that can be provisioned as a computing cloud.

By way of example and in accordance with an implementation, a user can access AC2 system 400 through user interface 450. The user can define the problem for which the user is requesting computing power (e.g., in terms of clock speed, processor power, and/or application operation). CCE 442 can make a determination on how the user's request is to be handled by the embedded processors of the industrial assets. This determination can include evaluating the location of the industrial assets, their available excess capacity, the time of day at the industrial assets, typical processor usage patterns by the industrial assets, the user's session duration, and other factors. The AAC2 system can include in its determination existing and future demands for the industrial asset to perform its primary purpose. Each industrial asset monitors its available resource and provides that information to the CCE.

For instance, if a user is located in the eastern United States and the request is made in the morning, it could be that assets located in Australia have available resource and no to minimal forecasted demand. As another example, a wind farm located in a region where the forecast is for mild to no breezes can also have available resources; similarly jet engines on planes parked overnight at an airport, or train engines in a rail yard.

The industrial asset's embedded processor continues to monitor its available resources. Should the primary purpose of the industrial asset require more processor power, the embedded processor can update the CCE with its now reduced availability. In response, the CCE can off-load that processor and assign another embedded processor to the user's requested task.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for leveraging industrial asset computing capacity into a distributed computing system by accessing unused and/or underutilized computer cycles available at the industrial asset, as described above.

The computer-readable medium may be a non-transitory computer-readable media including all forms and types of memory and all computer-readable media except for a transitory, propagating signal. In one implementation, the non-volatile memory or computer-readable medium may be external memory.

Machine-to-machine communications and machine intelligence provides a high degree of functionality to data analytics regarding the operation of the machines themselves. These communication and intelligence capabilities provide for collection and delivery of data, and the monitoring of the industrial assets. For example, PREDIX™ (General Electric Company, Schenectady, N.Y.) can be a platform for use in asset optimization, industrial automation, machine diagnostics, and optimization of industrial, healthcare, manufacturing and infrastructure management processes. This platform allows for implementation of a real-time, wide-area control environment to safely and securely deploy, manage, upgrade, and decommission an increasingly intelligent set of assets in a controlled, deterministic manner. The AC2 system disclosed herein provisions embedded controllers of industrial assets into a distributed computing system by accessing available processor cycles from under-utilized embedded controllers.

As will be appreciated based on the foregoing specification, the above-described embodiments of the disclosure may be implemented using computer programming or engineering techniques including computer software, firmware, hardware or any combination or subset thereof, wherein the technical effect of the embodying systems and methods described herein includes implementing an AC2 system that provides a distributed computing system that leverages the unused and/or underutilized computing processor power of industrial assets to provide computing power to programs, or applications, by accessing the industrial assets' control processor via a monitoring network to create the distributed computing system. Embodying AC2 systems can include a CCE structured to estimate the available computing capacity of individual industrial assets connected to the AC2.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A method of leveraging industrial asset computing capacity into a distributed computing system, the method comprising:
receiving from a requesting entity a request for available computing capacity, the request including at least one computational task;
determining the available computing capacity across a network of interconnected industrial assets, each industrial asset including at least one central controller;
allocating at least one of the interconnected industrial assets to perform at least a portion of the computational request;
providing the allocated industrial assets with computer executable instructions and data related to performing the computational request;
performing at least a portion of the computational request at the allocated industrial assets;
obtaining the results of the performing step from the allocated industrial assets; and
returning the obtained results to the requesting entity.

2. The method of claim 1, including correlating the obtained results into a cohesive result prior to the returning step.

3. The method of claim 1, the determining step including at least one of estimating the available computing capacity after receiving the request and accessing a computer record.

4. The method of claim 3, wherein the computer record contains previously estimated available computing capacity.

5. The method of claim 1, the determining step including basing the available computing capacity on each industrial asset's specific operational computing requirements.

6. The method of claim 1, including monetizing the available computing capacity by charging users for access to the available computing capacity.

7. A non-transitory computer-readable medium having stored thereon instructions which when executed by a processor cause the processor to perform a method of leveraging industrial asset computing capacity into a distributed computing system, the method comprising:
receiving from a requesting entity a request for available computing capacity, the request including at least one computational task;
determining the available computing capacity across a network of interconnected industrial assets, each industrial asset including at least one central controller;
allocating at least one of the interconnected industrial assets to perform at least a portion of the computational request;
providing the allocated industrial assets with computer executable instructions and data related to performing the computational request;
performing at least a portion of the computational request at the allocated industrial assets;
obtaining the results of the performing step from the allocated industrial assets; and
returning the obtained results to the requesting entity.

8. The medium of claim 7, including instructions to cause the processor to perform the step of correlating the obtained results into a cohesive result prior to the returning step.

9. The medium of claim 7, including instructions to cause the processor to perform the step determining step by at least one of estimating the available computing capacity after receiving the request and accessing a computer record.

10. The medium of claim 9, wherein the computer record contains previously estimated available computing capacity.

11. The medium of claim 7, including instructions to cause the processor to perform the determining step by basing the available computing capacity on each industrial asset's specific operational computing requirements.

12. The medium of claim 7, including monetizing the available computing capacity by charging users for access to the available computing capacity.

13. A system for leveraging industrial asset computing capacity into a distributed computing system, the system comprising:
an original equipment manufacturer technical service center (OEM TSCC) coupled to at least one of an electronic communication network and an Internet protocol version 6 communication channel;
a plurality of industrial assets in communication with the OEM TSCC by being coupled to at least one of the electronic communication network and the Internet protocol version 6 communication channel, at least a portion of the plurality of industrial assets including at least one remotely-accessible central controller;
the OEM TSCC including a computing estimator unit structured to estimate available computing capacity for the remotely-accessible central controllers;
the OEM TSCC including a central controller structured to execute computer-readable instructions that cause the central controller to perform a method including:
receiving from a requesting entity a request for available computing capacity, the request including at least one computational task;
determining the available computing capacity;
allocating at least one of the interconnected industrial assets to perform at least a portion of the computational request;
providing the allocated industrial assets with computer executable instructions and data related to performing the computational request;
performing at least a portion of the computational request at the allocated industrial assets;
obtaining the results of the performing step from the allocated industrial assets; and
returning the obtained results to the requesting entity.

14. The system of claim 13, including instructions to cause the central controller to correlate the obtained results into a cohesive result prior to the returning step.

15. The system of claim 13, including instructions to cause the central controller to perform the determining step by including at least one of estimating the available computing capacity after receiving the request and accessing a computer record.

16. The system of claim 13, including instructions to cause the central controller to store previously estimated available computing capacity in a computer record.

17. The system of claim 13, including instructions to cause the central controller to perform the determining step by basing the available computing capacity on each industrial asset's specific operational computing requirements.

18. The system of claim 13, including instructions to cause the central controller to monetize the available computing capacity by charging users for access to the available computing capacity.
